(19) United States
(12) Patent Application Publication
(10) Pub. No.: US 2022/0184925 A1
(43) Pub. Date: Jun. 16, 2022

(54) Laundry-resistant heterogeneous-material antimicrobial protective fabric manufacturing system

(71) Applicant: Yu-Cheng Huang, Kaohsiung (TW)

(72) Inventor: Yu-Cheng Huang, Kaohsiung (TW)

(21) Appl. No.: 17/122,973

(22) Filed: Dec. 15, 2020

(51) Int. Cl. B32B 15/14; B32B 15/095; B32B 5/02; D06C 27/00; B32B 7/14; B32B 27/40; B32B 27/36; B32B 5/24; B32B 15/09; D03D 15/283; D06P 1/00; D06P 3/52; D06P 7/00; B41F 17/00

(52) U.S. Cl. CPC B32B 15/14; B32B 2437/00; B32B 5/024; D06C 27/00; B32B 7/14; B32B 27/40; B32B 27/36; B32B 5/24; B32B 15/09; D03D 15/283; D06P 1/0036; D06P 3/52; D06P 7/005; B41F 17/003; B32B 2262/0276; D10B 2401/13; B32B 2307/748; B32B 15/095

(57) ABSTRACT

This invention relates to a functional textile manufacturing system. This system uses weaving equipment, dyeing and finishing equipment, shaping equipment, evaporation equipment, lamination equipment, roll adhesion equipment and printing equipment for production. Weaving equipment, dyeing and finishing equipment and shaping equipment are used for weaving, dyeing, washing and shaping to process low-cost polyester fibers into shaped fabric. Then, the evaporation equipment is used to evaporate a metal onto a plane release film to form a metal evaporation release film, and the lamination equipment, roll adhesion equipment and printing equipment are used to laminate the shaped fabric and the metal evaporation release film and to adhere a printed layer on the functional thin film. Such a manufacturing system can produce laundry resistant unconventional material antimicrobial protective fabric that features special temperature control, antimicrobial, waterproof, breathable, scratch resistant properties, as well as comfortable feeling.

### BACKGROUND OF INVENTION

### 1. Field of the Invention

The utility model relates generally to a laundry resistant unconventional material antimicrobial protective fabric manufacturing system, and more particularly to a manufacturing system with addition of a water-drawing agent, an evaporated metal layer and a functional thin film to form high-strength laundry resistant and antimicrobial protective fabrics.

### 2. Description of Related Art

Facing rapid development of material technology and increasingly high demand by current consumers for textile products, most textile manufacturers are paying more and more attention to the development of functional textiles with enhanced properties and simplified manufacturing processes to reduce production cost and increase profit margin. Over the recent years, the development of effective manufacturing processes for functional textiles is a big challenge for textile manufacturers, and takes a lot of human resources and R & D capabilities. In particular, the selection of appropriate raw materials for functional textile products requires in-house R & D staff to have sufficiently rich experience to find optimum materials. They need to utilize the different properties of various composite materials to produce functional textiles, and meanwhile, chemical reactions or interactions between the different materials that may cause function impairment shall be avoided.

The emergence of highly infectious bacteria and virus has caused a large number of infection cases throughout the world. Therefore, antimicrobial protective fabrics are developed and sold in large quantities. At present, the majority of antimicrobial protective fabrics is used only once, and are mainly provided to medical personnel. They are immediately disposed after use, therefore consuming a lot of resources and generating massive garbage. As such protective materials are high-priced and rarely used, general consumers seldom wear clothes made of such protective fabrics. However, there is still a need for consumers to have protective textile products for basic self protection. If they all use disposable protective clothing, it is not realistic to directly satisfy their needs. Therefore, it is an important task for relevant manufacturers to provide functional textile products that can be repeatedly washed and sterilized and that can offer basic protection.

It is reported that the current consumption of disposable protective clothing is amazingly high, and supplied often run short. Due to the under-supply, some doctors and nurses in England even use garbage bags to make protective gowns. This situation has caused wide public concern. Therefore, many relevant manufacturers tend to develop washable protective textile to make protective clothing that can be repeatedly washed and sterilized. A British garment manufacturer produced a three-layer protective gown, which can have waterproof and antimicrobial effect after washing with 73° C. hot water, and which allegedly can be repeatedly used for 100 times and still maintain its antimicrobial and waterproof function. Such protective gowns are mainly sold to medical care personnel for short-time protection and therefore have little consideration on the comfort of usage. Normally, the fabric does not have air or moisture permeability, and is not soft enough. They only consider its functional properties. It is naturally not suitable for general consumers to go out wearing such gowns. Therefore, general consumers will seldom buy such products. In order for a textile product to have protective effects and meanwhile meet the needs of general consumers, the production technique must be improved to process and combine different materials of different functions. As such, it has become an important task for textile manufacturers to find effective ways for mass production of textile products that feature antimicrobial protection, antistatic, waterproof, breathable, temperature-controllable, and scratch-resistant effects, as well as comfort of usage at the same time.

### SUMMARY OF THE INVENTION

In view of the above technical problems and based on years of experience in the research and development as well as practical production, the inventor of the utility model has made numerous improvements before proposing the utility model, aiming to enhance the production processes of the utility model and solve the drawbacks of the prior art.

The main objective of the utility model is to provide a streamlined protective fabric manufacturing system and to improve the whole manufacturing processes to produce laundry resistant unconventional material antimicrobial protective fabric that features good antimicrobial protection and waterproof property, and that can endure repeated washing.

Another objective of the utility model is to provide improved manufacturing processes to enhance the bonding of both the evaporated metal layer and the functional thin film layer to the fabric, so as to produce protective fabric having superior antimicrobial, waterproof, breathable, and scratch resistant effects.

A further objective of the utility model is to provide a special technique that uses weaving, dyeing and finishing, shaping, evaporation, lamination, roll adhesion and printing equipment as well as special manufacturing processes to manufacture laundry resistant unconventional material antimicrobial protective fabric, aiming to make a breakthrough over the prior art, and overcome the drawbacks of disposable protective clothing to provide antimicrobial, waterproof, convenient, and ultra-thin protective fabrics affordable to general consumers.

To achieve the above objectives, the utility model of a laundry resistant unconventional material antimicrobial protective fabric manufacturing system includes weaving equipment, dyeing and finishing equipment, shaping equipment, evaporation equipment, lamination equipment, roll adhesion equipment, and printing equipment; wherein, the weaving equipment weaves polyester fibers and recycled polyester fibers into a fabric. The dyeing and finishing equipment is configured subsequent to the weaving equipment. The dyeing and finishing equipment dyes and washes the fabric. The shaping equipment is configured subsequent to the dyeing and finishing equipment. The dyed and washed fabric is fed into the shaping equipment, and water-drawing agent is added. After drying, a shaped fabric is formed. The evaporation equipment is used to evaporate a metal onto a plane release film to form a metal evaporation release film. The metal evaporation release film includes a metal face and a release film face. The lamination equipment is configured subsequent to the shaping equipment and the evaporation equipment. The lamination equipment can attach the shaped fabric to the metal face of the metal evaporation release film. After releasing the release film face from the metal face, a metal evaporation plated fabric is formed. The roll adhesion equipment is configured subsequent to the lamination equipment. The laminated metal evaporation plated fabric is applied with an adhesive and is adhered to a functional thin film to form a metal evaporation plated protective fabric. In the end, the printing equipment is configured subsequent to the lamination equipment and is used to attach a printed layer on the outer layer of the metal evaporation plated protective fabric. Based on the utility model of a laundry resistant unconventional material antimicrobial protective fabric manufacturing system, the fabric, the evaporated metal, the functional thin film and the printed layer can be tightly and evenly bonded together.

Thus, based on the utility model, fabrics manufactured by the laundry resistant unconventional material antimicrobial protective fabric manufacturing system can have special temperature control as well as antimicrobial, waterproof, breathable, scratch resistant and comfortable properties. And the cost of protective clothes can be lowered to daily consumption levels. Consumers can afford protective clothes that can be washed repeatedly. Also, on the manufacturing side, through the streamlined manufacturing processes, the whole production cost as well as material cost will be significantly reduced. The features of the utility model are described below:
(1) Capable of special temperature control: the evaporation equipment is used to evaporate a metal onto a plane release film to form a metal evaporation release film, and the lamination equipment is used to attach the shaped fabric on the metal face of the metal evaporation release film, so that the shaped fabric can have a smooth and even evaporated metal layer. Users can choose to wear on either side according to the weather. The metal layer can enhance heat radiation and realize special temperature control.
(2) Having highly antimicrobial, waterproof, breathable, and scratch resistant properties: The fabric is dyed and washed by the dyeing and finishing equipment, and after that, the fabric is fed into the shaping equipment, and water-drawing agent is added. After drying, the roll adhesion equipment is used to apply an adhesive on the metal evaporation plated fabric and bond it with a functional thin film to form a metal evaporation plated protective fabric. Thus, the fabric can have highly antimicrobial, waterproof, and breathable effects. Meanwhile, through the tightly bonded functional thin film, it can have superior scratch resistance.
(3) Effectively enhancing comfort of usage: Using the printing equipment configured subsequent to the lamination equipment, the outer face of the metal evaporation plated protective fabric is attached with a printed layer. Thus, when the user's skin touches the fabric, through the printed layer, the wearing comfort is greatly enhanced.
(4) Reducing overall manufacturing costs and material costs: Through unique manufacturing processes and special processing methods, the utility model can use low-cost polyester fibers to produce fabrics having temperature-controllable, antimicrobial, waterproof, breathable, scratch resistant and comfortable effects, and can significantly reduce the overall manufacturing costs and material costs. As a result, products manufactured using the utility model of a laundry resistant unconventional material antimicrobial protective fabric manufacturing system can have competitive cutting edge in term of price.

### BRIEF DESCRIPTION OF THE DRAWINGS

FIG. 1 is a schematic view of a laundry resistant unconventional material antimicrobial protective fabric manufacturing system according to the utility model.

### DETAILED DESCRIPTION OF THE INVENTION

For better understanding of the objectives, technical solutions and advantages of the utility model, further detailed descriptions are provided below with reference to a preferred embodiment of the utility model. It is to be noted, however, that the embodiment is not intending to limit the scope of the utility model. Any modification, equivalent substitution, and improvement without departing from the spirit and principle of this utility model should be covered in the protection scope of the utility model. It is apparent that those skilled in the art can make various modifications and variations to the utility model using common technical knowledge and means in the related field.

The technical features of the utility model are described below based on a preferred embodiment and with reference to the accompanying drawings to provide an insight into the utility model.

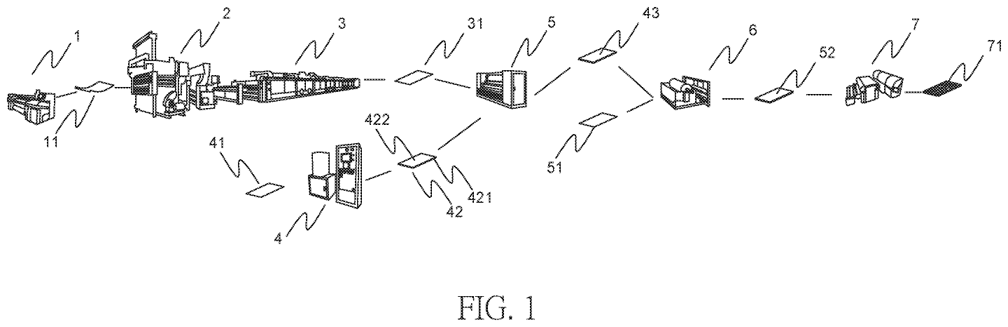

The utility model is a “laundry resistant unconventional material antimicrobial protective fabric manufacturing system”. FIG. 1 is a schematic view of the laundry resistant unconventional material antimicrobial protective fabric manufacturing system according to the utility model. It includes weaving equipment (1), dyeing and finishing equipment (2), shaping equipment (3), evaporation equipment (4), lamination equipment (5), roll adhesion equipment (6), and printing equipment (7). The weaving equipment (1) is used to weave 50D˜300D polyester fibers and recycled polyester fibers into a fabric (11). The dyeing and finishing equipment (2) is configured subsequent to the weaving equipment (1). The dyeing and finishing equipment (2) dyes and washes the fabric (11), so that the fabric (11) has a specific color, and the original agent or foreign matters are removed through washing. The shaping equipment (3) is configured subsequent to the dyeing and finishing equipment (2). The dyed and washed fabric (11) is fed into the shaping equipment (3), and water-drawing agent is added, and then the fabric is dried to form a shaped fabric (31). Then, the evaporation equipment (4) is used to evaporate a metal onto the plane release film (41) to form a metal evaporation release film (42), so that the metal evaporation release film (42) has a metal face (421) and a release film face (422). The lamination equipment (5) is configured subsequent to the shaping equipment (3) and the evaporation equipment (4). The lamination equipment (5) can attach the shaped fabric (31) to the metal face (421) of the metal evaporation release film (42). After releasing the release film (41) from the metal face (421), a metal evaporation plated fabric (43) is produced. The roll adhesion equipment (6) is configured subsequent to the lamination equipment (5). The laminated metal evaporation plated fabric (43) is applied with an adhesive and attached to a functional thin film (51) to form a metal evaporation plated protective fabric (52). The printing equipment (7) is configured subsequent to the lamination equipment (5). The outer layer of the metal evaporation plated protective fabric (52) is attached with a printed layer (71). Thus, a laundry resistant unconventional material antimicrobial protective fabric with multiple composite functional layers is produced. Through the utility model of a laundry resistant unconventional material antimicrobial protective fabric manufacturing system, relatively low-priced polyester fibers and recycled polyester fibers can be used for the production of protective fabrics to significantly reduce the cost of raw materials. Also, through the manufacturing system disclosed in the utility model, the metal layer evaporated on the laundry resistant unconventional material antimicrobial protective fabric can be evenly and completely attached to the fabric. The composite materials of each of the layers can be bonded together stably to form a fabric featuring special temperature control through the evaporated metal layer, antimicrobial, waterproof, and breathable abilities through the functional thin film, and highly comfortable feeling through the printed layer.

Although the utility model has been explained in relation to its preferred embodiment, it is to be understood that many other possible modifications and variations can be made without departing from the spirit and scope of the utility model as hereinafter claimed.

To summarize, the embodiment of the utility model can truly achieve the expected effects. The detailed structure of this utility model are not seen in similar products, or disclosed before the application of this utility model. As such, according to the provisions and requirements of the Patent Law, an application for patent is submitted herein. Your audit and approval will be highly appreciated.

1. A laundry resistant unconventional material antimicrobial protective fabric manufacturing system, including:
weaving equipment, said weaving equipment being used to weave polyester fibers and recycled polyester fibers into a fabric;
dyeing and finishing equipment, said dyeing and finishing equipment being configured subsequent to the weaving equipment, and said dyeing and finishing equipment being used to dye and wash the fabric;
shaping equipment, said shaping equipment being configured subsequent to the dyeing and finishing equipment; dyed and finished fabric is fed into the shaping equipment, where water-drawing agent is added, and then the fabric is dried to form a shaped fabric;
evaporation equipment, said evaporation equipment being used to evaporate a metal onto a plane release film to form a metal evaporation release film, so that the metal evaporation release film has a metal face and a release film face;
lamination equipment, said lamination equipment being configured subsequent to the shaping equipment and the evaporation equipment, said lamination equipment being used to attach the shaped fabric to the metal face of the metal evaporation release film; after releasing the release film face from the metal face, a metal evaporation plated fabric is formed;
roll adhesion equipment, said roll adhesion equipment being configured subsequent to the lamination equipment, used to laminate the metal evaporation plated fabric with a functional thin film to form a metal evaporation plated protective fabric; and
printing equipment, said printing equipment being configured subsequent to the lamination equipment, and used to apply a printed layer to the on the outer layer of the metal evaporation plated protective fabric.

2. The laundry resistant unconventional material antimicrobial protective fabric manufacturing system defined in claim 1, wherein said fabric is made by weaving Denier 50D˜300D polyester fibers and recycled polyester fibers together.

3. The laundry resistant unconventional material antimicrobial protective fabric manufacturing system defined in claim 1, wherein said dyeing and finishing equipment includes any of an upward running dyeing machine, a downward running dyeing machine, or a crawler-type dyeing machine, or their combinations.

4. The laundry resistant unconventional material antimicrobial protective fabric manufacturing system defined in claim 1, wherein said shaping equipment includes a drying oven, and the temperature range of the drying oven is 130° C.˜200° C.

5. The laundry resistant unconventional material antimicrobial protective fabric manufacturing system defined in claim 1, wherein, the bonding between the shaped fabric and the metal surface of the metal evaporation release film and the bonding between the metal evaporation plated fabric and the functional thin film are realized by using spot patch method.

6. The laundry resistant unconventional material antimicrobial protective fabric manufacturing system defined in claim 1, wherein said metal evaporation release film is attached to the shaped fabric through heat transfer.

7. The laundry resistant unconventional material antimicrobial protective fabric manufacturing system defined in claim 1, wherein said functional thin film is TPU film or TPEE film.

8. The laundry resistant unconventional material antimicrobial protective fabric manufacturing system defined in claim 1, wherein said functional thin film has a thickness of 10˜30 um.

9. The laundry resistant unconventional material antimicrobial protective fabric manufacturing system defined in claim 1, wherein said printed layer has a thickness of 10˜3 mm.
